(19) United States
(12) Patent Application Publication
(10) Pub. No.: US 2024/0101874 A1
(43) Pub. Date: Mar. 28, 2024

(54) CATIONICALLY CURABLE ADHESIVE WITH DEFINED COLOURATION IN THE CURED STATE

(71) Applicant: tesa SE, Norderstedt (DE)

(72) Inventors: Christian Schuh, Hamburg (DE); Sven Heidsieck, Hamburg (DE); Oleg Brinster, Hamburg (DE); Marten Papenbroock, Hamburg (DE)

(73) Assignee: tesa SE, Norderstedt (DE)

(21) Appl. No.: 18/374,512

(22) Filed: Sep. 28, 2023

(30) Foreign Application Priority Data
Sep. 28, 2022 (DE) 10 2022 124 903.4

(51) Int. Cl. C09J 131/04; C09J 4/06; C09J 7/38; C09J 11/06

(52) U.S. Cl. CPC C09J 131/04; C09J 4/06; C09J 7/381; C09J 11/06; C09J 2301/302; C09J 2301/408; C09J 2301/414; C09J 2431/00

(57) ABSTRACT

The invention relates to a curable adhesive comprising: a) one or more (co)polymers, b) one or more polymerizable epoxide compounds, c) one or more cationic initiators, and d) one or more dyes, wherein the one or the two or more dyes are selected from the group consisting of Benzoyl-Leuco-Methylene Blue, Leuco-Crystal Violet, Crystal Violet Lactone, Ethyl Violet, Methyl Violet, Methyl Green, Ethyl Green, Nile Blue, 1,4-bis(mesitylamino)anthraquinone and copper phthalocyanine.

The invention relates to a curable adhesive and to a reactive adhesive tape comprising such a curable adhesive. Also disclosed is the use of such curable adhesives and reactive adhesive tapes for the bonding of two or more components.

The joining of separate elements is one of the central processes in manufacturing. Besides other methods, such as welding and soldering, for example, an important significance is nowadays accorded in particular to adhesive bonding, i.e. to joining using an adhesive. One alternative to the use of formless adhesives which are applied from a tube, for example, are so-called adhesive tapes. Known from everyday life in particular are pressure-sensitive adhesive tapes, where a pressure-sensitive adhesive provides the bonding effect, which under typical ambient conditions is durably tacky and also adhesive. Such pressure-sensitive adhesive tapes may be applied by pressure to a substrate and remain adhering there, but later on can be removed again more or less without residue.

Particularly for use in industrial manufacturing, however, there is also another type of adhesive tapes of great significance. In these adhesive tapes, which are sometimes also referred to as reactive adhesive tapes, a curable adhesive is employed. In the state intended for application, curable adhesives of these kinds have not yet attained their maximum crosslinking, and can be cured by external influences, with initiation of the polymerization in the curable adhesive and a consequent increase in the crosslinking. This is accompanied by changes in the mechanical properties of the now cured adhesive, with increases in particular in the viscosity, the surface hardness and the strength.

Curable adhesives are known in the prior art and from a chemical standpoint may have very different compositions. Common to these curable adhesives is the possibility of initiating the cross-linking reaction by means of external influencing factors, such as by supply of energy, for example, in particular through thermal curing, plasma curing or radiation curing, and/or by contact with a substance that promotes the polymerization, as is the case, for example, with moisture-curing adhesives. Illustrative adhesives are disclosed for example in DE 102015222028 A1, EP 3091059 A1, EP 3126402 B1, EP 2768919 B1, DE 102018203894 A1, WO 2017174303 A1, WO 2020119898 A1, JP 4611463 B2 and U.S. Pat. No. 4,661,542 A.

One type of curable adhesives of particular industrial relevance are the cationically curable epoxy adhesives, whose handling and application properties and also the realizable adhesive properties are seen as being particularly advantageous for a wide spectrum of industrial applications. In spite of the known advantages of cationically curable epoxy adhesives, however, they also have qualities which are perceived as being disadvantageous for use in modern manufacturing processes.

Indeed, the activation of cationically curable epoxy adhesives by heat or UV light releases a strong acid which starts the cationic epoxide curing. A consequence of this is that in such curable adhesives, in the course of curing, there may be greatly fluctuating and demanding chemical conditions, with the pH value in particular displaying a great dependence on time and possibly also experiencing sharp absolute fluctuations in the course of curing, through to the point of highly acidic conditions. Not only the epoxide compounds but also all of the other components in the curing adhesive are exposed to these fluctuating chemical conditions. A consequence of this is that the physicochemical properties of other constituents in the curing adhesive may change, particularly if they exhibit, for example, a dependence on pH; for the skilled person, the complexity of the systems makes the changes that may be expected difficult to predict.

One class of compounds which are regularly used in adhesives and which in many cases display a pronounced pH dependence in their physicochemical properties are dyes; the absorption characteristics of these dyes may be influenced by the pH, but also by other chemical processes in the curing adhesive. In many cases, this occurs on the one hand as a result of the direct interaction of numerous dyes with the superacid released by the cationic initiator, and also by the change in the pH. Further constituents of initiator systems may also interact with the dyes in an unexpected way. Other dyes as well exhibit unwanted and usually difficult-to-predict changes in their colour under different service conditions, especially at elevated temperatures and/or during the cure times of curable adhesives. In practice it is found here, in many cases, that especially those dyes which enable a blue colouration of adhesives at least prior to curing display difficult-to-predict colour changes when used in cationically curable epoxy adhesives, in the course of curing, and that it is very challenging to obtain blue cured adhesives in many cases.

The problems described above are in no way a purely aesthetic problem, in view of the requirement of modern manufacturing processes which rely on the bonding of components using cationically curable epoxy adhesives. Indeed, in many cases, the colouring of adhesives does not have the primary purpose of offering an attractive view for the personnel involved in the manufacturing process. Instead, the colouration of a cured adhesive and hence its absorption characteristics for electromagnetic radiation of a wavelength in the range of visible light are important parameters—the non-invasive sensors in modern manufacturing processes may be attuned to these parameters. In methods for process control and quality assurance, optical sensors may be used, for example, to detect whether the cured adhesive or a corresponding adhesive tape has been positioned at the correct place, the thickness of material corresponds to the mandates, or any release liners have been completely removed. For these tasks, with a view to the plant costs and the necessary computing power, it is not possible to employ complex image processing systems arbitrarily, which could also be used, for example, to compensate complex colour changes in the object observed, using artificial intelligence. Instead, the sensors used are of course to be extremely simple and robust, with the use of simple colour sensors, for example, being desirable. This, however, necessitates reliable colour qualities in the cured adhesives, which many of the cationically curable epoxy adhesives known from the prior art are unable to provide, for the reasons described above. These problems are exacerbated by a particularly pronounced demand, in numerous sectors, for blue cationically curable epoxy adhesives, which, as explained above, are particularly difficult to obtain. This demand may be a result, for example, of the technical nature of the colour sensors installed in the workshops, or the contrasts with the bonded substrate that are desired by the user. However, it may also be governed by other technical mandates, as for example by the requirement for particular transmission characteristics of electromagnetic radiation through the adhesive tape, to enable downstream radiation-based analysis of the bonded substrate.

The primary object of the present invention was to eliminate or at least reduce the disadvantages described above for the prior art.

In particular, the object of the present invention was to specify a cationically curable epoxide-based adhesive whose colour after curing can be established in a particularly precise way and whose absorption characteristics for electromagnetic radiation in the range of visible light in the cured state show no change, or only little change, accordingly, as a function of the chemical conditions experienced in the course of curing. A mandate for the present invention was that the curable adhesive to be specified ought to be able to have a blue colouration after curing.

Furthermore, an object of the present invention was that the curable adhesive to be specified ought to be able to be realized as an at least partly transparent adhesive with a low degree of opacity.

It was likewise an object of the present invention that the curable adhesive to be specified ought to be able to be realized as a pressure-sensitive adhesive, but also as a liquid adhesive, with desirably little or no sedimentation of the dye.

It was a further object of the present invention that the curable adhesive to be specified ought to have maximum flexibility in terms of the rest of the chemical composition and hence in terms of the physicochemical properties achievable in the course of curing. In particular, the curable adhesive to be specified ought predominantly also to be preparable from components which are used for conventional curable adhesives.

A fundamental proviso here was that the curable adhesive to be specified ought to be reliably curable and ought to exhibit excellent technical adhesive properties.

A supplementary object of the present invention was the provision of an advantageous reactive adhesive tape or pressure-sensitive adhesive tape.

Moreover, a secondary object of the present invention was to provide a use of the curable adhesives or reactive adhesive tapes to be specified, for the bonding of two or more components.

The inventors of the present invention have now found that the objects described above can be achieved, surprisingly, if one or more specific dyes, as defined in the claims, are used in epoxide-based curable adhesives which cure via a cationic initiator. Without a chemical reason being apparent to the inventors, the resultant curable adhesives surprisingly exhibit excellent colour stability in the cured adhesive and in particular also enable the production of blue curable adhesives, which even after prolonged storage under demanding environmental conditions exhibit advantageous colour stability and display precision-adjustable absorption characteristics for electromagnetic radiation in the range of visible light.

To the knowledge of the inventors, the specific dyes display their advantageous behaviour substantially independently of the chemical nature of the other components, and are therefore compatible with a broad range of industrially relevant curable adhesives. Moreover, the dyes have good solubility in the other constituents of the curable adhesive, and so liquid curable adhesives can also be obtained in an efficient way, and in principle a low opacity is achievable. On the basis of the experiments by the inventors, the curable adhesives display good curing characteristics and permit flexible establishment of the technical adhesive properties in respect of the particular requirements of the application.

The objects stated above are therefore achieved by the subject matter of the invention, as defined in the claims. Preferred configurations according to the invention are evident from the dependent claims and from the observations that follow.

Embodiments referred to below as preferred are combined, in particularly preferred embodiments, with features of other embodiments referred to as preferred. Especially preferred, therefore, are combinations of two or more of the embodiments referred to below as particularly preferred. Likewise preferred are embodiments in which a feature of one embodiment that is referred to to any extent as being preferred is combined with one or more further features of other embodiments which are referred to to any extent as being preferred. Features of preferred pressure-sensitive adhesive tapes and uses are apparent from the features of preferred curable pressure-sensitive adhesives.

Where, below for an element, both specific amounts or fractions of this element, for example the (co)polymers or the polymerizable epoxide compounds, and preferred configurations of the element are disclosed, the specific amounts or fractions of the elements with preferred configuration are also disclosed, in particular. Moreover, in the case of the corresponding specific total amounts or total fractions of the elements, it is disclosed that at least some of the elements may have preferred configuration and also, in particular, that elements of preferred configuration may be present again in the specific amounts or fractions within the specific total amounts or total fractions.

The invention relates to a curable adhesive comprising:
a) one or more (co)polymers,
b) one or more polymerizable epoxide compounds,
c) one or more cationic initiators, and
d) one or more dyes,
wherein the one or the two or more dyes are selected from the group consisting of Benzoyl-Leuco-Methylene Blue, Leuco-Crystal Violet, Crystal Violet Lactone, Ethyl Violet, Methyl Violet, Methyl Green, Ethyl Green, Nile Blue, 1,4-bis(mesitylamino)anthraquinone and copper phthalocyanine.

Curable adhesives are comprehensively known to the skilled person, as described above, from the prior art; the individual opponents indicated above are also known in isolation to the skilled person and are available commercially in different variations from numerous different suppliers—below, moreover, preferred and illustrative representatives of the individual components are disclosed.

In agreement with the understanding of the skilled person, these above-defined constituents are used in each case as “one or more”. The designation “one or more” refers here, in a manner customary within the sector, to the chemical nature of the compounds in question and not to their amount of substance. For example, the polymerizable epoxide compound in the curable pressure-sensitive adhesive may comprise exclusively epoxycyclohexylmethyl 3′,4′-epoxycyclohexanecarboxylate, which would mean that the curable pressure-sensitive adhesive comprises a multiplicity of the molecules in question.

The curable adhesive of the invention is curable. As a result of the facility for curing, the curable adhesive is able to function as a structural adhesive after curing. According to DIN EN 923:2006-01, structural adhesives are demonstrably suitable for producing load-bearing constructions in which the adhesive bond can be stressed over relatively long periods of time with a high percentage value of the maximum breaking force without failure (according to the ASTM definition: “bonding agents used for transferring required loads between adherends exposed to service environments typical for the structure involved”). They are, accordingly, adhesives for bonds which can be highly stressed chemically and physically and which in the cured state contribute to the strengthening of the adhesive tapes.

The skilled person understands that, given the object of providing curable adhesives which after curing are blue, it follows that this involves a curable adhesive of the invention, wherein the curable adhesive can be converted into a blue cured adhesive by curing. Preferred accordingly is a curable adhesive of the invention wherein the curable adhesive before curing is a blue adhesive.

Fundamental to the curable adhesive of the invention is that the curable adhesive comprises one or more specific dyes which are selected from the group consisting of Benzoyl-Leuco-Methylene Blue (CAS: 1249-97-4), Leuco-Crystal Violet (CAS: 603-48-5), Crystal Violet Lactone (CAS: 1552-42-7), Ethyl Violet (CAS: 2390-59-2), Methyl Violet (CAS: 8004-87-3), Methyl Green (CAS: 7114-03-6), Ethyl Green (CAS: 14855-76-6), Nile Blue (CAS: 2381-85-3 (hydrochloride), 3625-57-8 (sulfate) and CAS: 53340-16-2 (perchlorate)), 1,4-bis(mesitylamino)anthraquinone (CAS: 116-75-6) and copper phthalocyanine (29H,31H-phthalocyanine copper complex, CAS: 147-14-8).

In the experiments by the inventors, the most appealing results overall in terms of colouration were achieved with Benzoyl-Leuco-Methylene Blue, Leuco-Crystal Violet, Crystal Violet Lactone, Ethyl Violet, Methyl Violet, Nile Blue, 1,4-bis(mesitylamino)anthraquinone and copper phthalocyanine. Preferred accordingly first of all is a curable adhesive of the invention wherein the one or the two or more dyes are selected from the group consisting of Benzoyl-Leuco-Methylene Blue, Leuco-Crystal Violet, Crystal Violet Lactone, Ethyl Violet, Methyl Violet, Nile Blue, 1,4-bis(mesitylamino)anthraquinone and copper phthalocyanine.

In in-house experiments, the inventors found that of the dyes indicated above, the Leuco-Crystal Violet and the Crystal Violet Lactone surprisingly in certain cases influence the curing of the curable adhesive more greatly than the other dyes. In certain experiments, for Leuco-Crystal Violet and Crystal Violet Lactone, a thermal aftercuring was needed in order to achieve a high bonding strength. In some manufacturing processes and for certain curable adhesives, such thermal aftercuring is envisaged in any case, and so this is a minor disadvantage in particular applications. Nevertheless, the inventors regard the other dyes as more advantageous with a view to the curing characteristics. Preferred, correspondingly, is a curable adhesive of the invention wherein the one or the two or more dyes are selected from the group consisting of Benzoyl-Leuco-Methylene Blue, Ethyl Violet, Methyl Violet, Methyl Green, Ethyl Green, Nile Blue, 1,4-bis(mesitylamino)anthraquinone and copper phthalocyanine. Particularly preferred, correspondingly, is a curable adhesive of the invention wherein the one or the two or more dyes are selected from the group consisting of Benzoyl-Leuco-Methylene Blue, Ethyl Violet, Nile Blue, 1,4-bis(mesitylamino)anthraquinone and copper phthalocyanine. With further preference there is no thermal aftercuring or no need for thermal aftercuring.

In their experiments, the inventors found outstanding blue stability and particularly favourable curing characteristics for copper phthalocyanine in particular. Especially preferred, correspondingly, is a curable adhesive of the invention wherein the dye is copper phthalocyanine.

In spite of the advantageous results observed with copper phthalocyanine this die in some cases shows a less advantageous behaviour than the other dyes in terms of solubility in curable adhesives of the invention. For certain applications, it may prove less advantageous in liquid curable adhesives. Against this background, for certain applications, preference is also given to curable adhesives of the invention wherein the one or the two or more dyes are selected from the group consisting of Benzoyl-Leuco-Methylene Blue, Leuco-Crystal Violet, Crystal Violet Lactone, Ethyl Violet, Methyl Violet, Methyl Green, Ethyl Green, Nile Blue and 1,4-bis(mesitylamino)anthraquinone, preferably selected from the group consisting of Benzoyl-Leuco-Methylene Blue, Ethyl Violet, Methyl Violet, Methyl Green, Ethyl Green, Nile Blue and 1,4-bis(mesitylamino)anthraquinone or from the group consisting of Benzoyl-Leuco-Methylene Blue, Leuco-Crystal Violet, Crystal Violet Lactone, Ethyl Violet, Methyl Violet, Nile Blue and 1,4-bis(mesitylamino)anthraquinone, with particular preference Benzoyl-Leuco-Methylene Blue, Ethyl Violet, Nile Blue and 1,4-bis(mesitylamino)anthraquinone.

The curable adhesives of the invention may advantageously in principle also be provided as liquid systems, since the specific dyes dissolve in the other components and/or at least do not have a strong tendency towards sedimentation. For later use in the end application, however, it is advantageous for the handling properties if the curable adhesive exhibits an intrinsic pressure-sensitive adhesiveness and hence can be classified as a pressure-sensitive adhesive. Prior to the curing of the curable adhesives, the pressure-sensitive adhesiveness permits reliable and secure application of the reactive adhesive tapes on the substrate. Preferred accordingly is a curable adhesive of the invention wherein the curable adhesive is a pressure-sensitive adhesive. For implementation of the pressure-sensitive adhesiveness, it is useful in the estimation of the inventors to set the combined mass fraction of the (co)polymers in the curable adhesive at 25% or more, preferably 30% or more, more preferably 35% or more.

A pressure-sensitive adhesive (PSA), in agreement with the understanding of the skilled person, is an adhesive which possesses pressure-sensitive adhesive properties, i.e. has the capacity to enter into a durable bond with respect to a substrate even under relatively weak applied pressure. Corresponding pressure-sensitive adhesive tapes are typically redetachable from the substrate substantially without residue after use, and in general have a permanent intrinsic tack even at room temperature, meaning that they have a certain viscosity and touch-tackiness, so that they wet the surface of a substrate even under low applied pressure. The pressure-sensitive adhesiveness of a pressure-sensitive adhesive tape is a product of the use as adhesive of a pressure-sensitive adhesive. Without wishing to be tied to this theory, it is frequently assumed that a pressure-sensitive adhesive may be considered to be a fluid of extremely high viscosity with an elastic component, accordingly having characteristic viscoelastic properties which lead to the above-described durable intrinsic tackiness and pressure-sensitive adhesive capability. It is assumed that with such PSAs, on mechanical deformation, there are viscous flow processes and there is development of elastic forces of resilience. The viscous flow component serves to achieve adhesion, while the elastic forces of resilience component are needed in particular for the achievement of cohesion. The relationships between the rheology and the pressure-sensitive adhesiveness are known in the prior art and described for example in Satas, “Handbook of Pressure Sensitive Adhesives Technology”, Third Edition (1999), pages 153 to 203. To characterize the extent of the elastic and viscous components, it is usual to employ the storage modulus (G′) and the loss modulus (G″), which may be ascertained by dynamic mechanical analysis (DMA), using a rheometer, for example, as disclosed for example in WO 2015/189323. For the purposes of the present invention, an adhesive is understood preferably to have pressure-sensitive adhesiveness and hence to be a pressure-sensitive adhesive when at a temperature of 23° C. in the deformation frequency range from 10⁰ to 10¹ rad/sec, G′ and G″ are each situated at least partly within the range from 10³ to 10⁷ Pa.

Below, the components contained in the curable pressure-sensitive adhesive of the invention are explained in more detail. Accordingly, the inventors have succeeded in identifying respectively particularly preferred configurations and mass fractions for the individual components, allowing performance-capable curable adhesives of the invention to be obtained. In a manner customary in the sector, the mass fractions are reported as combined mass fractions of the one or of the two or more components, expressing the fact that the mass fraction of the components configured accordingly, taken together, meets the corresponding criteria; in the absence of indications to the contrary, the mass of the curable pressure-sensitive adhesive is the reference system in each case.

The skilled person understands that the (co)polymers customarily have the role of the film-former, which is especially important when, for example, pressure-sensitive adhesives are to be obtained. In other words, with the use of (co)polymers which are customary in the field of bonding technology, the adhesive is thus a curable adhesive wherein the one or the two or more (co)polymers are selected from the group consisting of film-forming (co)polymers.

Preferred here, additionally or alternatively, is a curable adhesive of the invention, wherein the one or the two or more (co)polymers are selected from the group consisting of poly(meth)acrylates, polyurethanes, polyvinylacetals, such as e.g. polyvinylbutyral, polysiloxanes, synthetic rubbers, polyesters, phenoxy polymers, polyvinyl alcohols, polyvinyl alcohol copolymers, and alkene-vinyl acetate copolymers, preferably are selected from the group consisting of poly(meth)acrylates, phenoxy polymers, polyvinyl alcohols, polyvinyl alcohol copolymers, polyvinylacetals, such as e.g. polyvinylbutyral, and ethylene-vinyl acetate copolymers (EVA or EVAC, poly(ethylene-co-vinyl acetate)), especially are selected from the group consisting of poly(meth)acrylates, phenoxy polymers and ethylene-vinyl acetate copolymers.

Additionally or alternatively it is also possible as (co)polymers to use block copolymers, for example (meth)acrylate block copolymers. Corresponding examples are disclosed for example in the documents US 2011003947 A1, US 20080200589 A1, US 2007078236 A1, US 2007078236 A1, US 2012196952 A1, US 2016032157 A1, US 2008146747 A1 and US 2016230054 A1.

The number-average molar masses Mn of the (co)polymers are preferably in a range from 50 000 to 10 000 000 g/mol, more preferably in a range from 100 000 to 5 000 000 g/mol, very preferably in a range from 150 000 to 2 000 000 g/mol. The figures for the number-average molar mass Mn are based here on the determination by gel permeation chromatography (GPC). The determination is made on 100 μl of clear-filtered sample (sample concentration 4 g/l). The eluent used is tetrahydrofuran with 0.1% by volume of trifluoroacetic acid. The measurement takes place at 25° C. The pre-column used is a column of type PSS-SDV, 5 μm, 10³ Å, 8.0 mm*50 mm (details here and below in the order: type, particle size, porosity, internal diameter*length; 1 Å=10⁻¹⁰ m). Separation takes place using a combination of the columns of type PSS-SDV, 5 μm, 10³ Å and also 10⁵ Å and 10⁶ Å each of 8.0 mm*300 mm (columns from Polymer Standards Service; detection by means of Shodex RI71 differential refractometer). The flow rate is 1.0 ml per minute. Calibration takes place in the case of polyacrylates against PMMA standards (polymethyl methacrylate calibration) and otherwise (resins, elastomers) against PS standards (polystyrene calibration).

Irrespective of the specific selection of the (co)polymers, preference is given to a curable adhesive of the invention wherein the combined mass fraction of the (co)polymers in the curable adhesive is in the range from 1% to 70%, preferably in the range from 2% to 60%, more preferably in the range from 5% to 50%, very preferably in the range from 10% to 40%, based on the mass of the curable adhesive. As explained above, it is useful, for obtaining a pressure-sensitive curable adhesive, to set the combined mass fraction of the (co)polymers in the curable adhesive at 25% or more, preferably 30% or more, more preferably 35% or more, very preferably in a range from 25% to 40%.

As well as the (co)polymers, the curable adhesive of the invention also comprises at least one polymerizable epoxide compound and also, optionally, further polymerizable compounds. These compounds together form that part of the curable adhesive which is frequently referred to by the skilled person as reactive resin.

In agreement with the understanding of the skilled person, the expression “polymerizable” here refers to the capacity of these compounds, where appropriate after suitable activation, to enter into a polymerization reaction. In the case of the polymerizable epoxide compounds, the polymerizability is enabled, for example, by the epoxide groups.

In agreement with the understanding of the skilled person, epoxide compounds are compounds which carry at least one oxirane group. They may be aromatic or aliphatic, more particularly cycloaliphatic, in nature. Polymerizable epoxide compounds may comprise not only monomeric but also oligomeric or polymeric epoxide compounds. Polymerizable epoxide compounds frequently have on average at least two epoxide groups per molecule, preferably more than two epoxide groups per molecule. Preferred accordingly is a curable adhesive of the invention wherein the one or the two or more polymerizable epoxide compounds are selected from the group consisting of epoxide compounds having two or more epoxide groups, preferably two epoxide groups.

The oligomeric or polymeric epoxide compounds usually comprise linear polymers having terminal epoxide groups (e.g. a diglycidyl ether of a polyoxyalkylene glycol), polymers having framework oxirane units (e.g. polybutadiene-polyepoxide) and polymers having epoxide side groups (e.g. a glycidyl methacrylate polymer or copolymer). The molecular weight of such epoxide compounds may vary from 58 to about 100 000 g/mol or more, with the molecular weight being an important parameter for adjusting the dynamic viscosity. Illustrative polymerizable epoxide compounds comprise epoxycyclohexane carboxylates, such as, for example, 4-epoxycyclohexylmethyl 3,4-epoxycyclohexanecarboxylate, 3,4-epoxy-2-methylcyclohexyl-methyl 3,4-epoxy-2-methylcyclohexanecarboxylate and bis(3,4-epoxy-6-methylcyclohexylmethyl) adipate. Further examples of polymerizable epoxide compounds are, for example, disclosed in U.S. Pat. No. 3,117,099 A. Further polymerizable epoxide compounds particularly useful in the application of this invention comprise glycidyl ether monomers, as are disclosed for example in U.S. Pat. No. 3,018,262. Examples are the glycidyl ethers of polyhydric phenols, obtained by reacting a polyhydric phenol with an excess of chlorohydrin, such as epichlorohydrin (e.g. the diglycidyl ethers of 2,2-bis(2,3-epoxypropoxyphenol)propane). In particular, diglycidyl ethers of bisphenols, such as e.g. bisphenol-A (4,4′-(propane-2,2-diyl)diphenol) and bisphenol-F (bis(4-hydroxyphenyl)methane). Such reaction products are available commercially in different molecular weights and aggregate states (for example, so-called type 1 to type 10 BADGE resins). Typical examples of liquid bisphenol-A diglycidyl ethers are Epikote 828, D.E.R.331 and Epon 828. Typical solid BADGE resins are Araldite GT6071, GT7072, Epon 1001 and D.E.R. 662. Further reaction products of phenols with epichlorohydrin are the phenol and cresol novolac resins such as the Epiclon types or Araldite EPN and ECN types (e.g. ECN1273), for example.

Preferred in the estimation of the inventors is a curable adhesive of the invention wherein the one or the two or more polymerizable epoxide compounds are selected from the group consisting of epoxide compounds having at least one cycloaliphatic group, more particularly a cyclohexyl group or dicyclopentadienyl group. Preferred, additionally or alternatively, is a curable adhesive of the invention wherein the one or the two or more polymerizable epoxide compounds are selected from the group consisting of bisphenol-A diglycidyl ethers and bisphenol-F diglycidyl ethers, preferably bisphenol-A diglycidyl ethers.

In the estimation of the inventors, particularly advantageous curable adhesives may be obtained by using two or more different polymerizable epoxide compounds, especially if they differ at room temperature in terms of their aggregate state. Preferred is a curable adhesive of the invention which comprises one or more polymerizable epoxide compounds selected from the group of epoxide compounds which at 25° C. are solids or substances of high viscosity, having a dynamic viscosity of 50 Pa s or more, preferably 100 Pa s or more, more preferably 150 Pa s or more, and/or which comprises one or more polymerizable epoxide compounds selected from the group of epoxide compounds which at 25° C. are a liquid having a dynamic viscosity of 40 Pa s or less, preferably 20 Pa s or less, very preferably 10 Pa s or less. For the purposes of the present invention, the dynamic viscosity is determined according to DIN 53019-1 from 2008; at 25° C., with a shear rate of 1 s⁻¹.

Preferred, irrespective of the specific selection of the polymerizable epoxide compounds, is a curable adhesive of the invention wherein the combined mass fraction of the polymerizable epoxide compounds in the curable adhesive is in the range from 35% to 95%, preferably in the range from 40% to 90%, more preferably in the range from 45% to 85%, very preferably in the range from 50% to 80%, based on the mass of the curable adhesive.

The curable adhesives of the invention comprise at least one cationic initiator. Such cationic initiators are known to the skilled person on the basis of their common general knowledge and are frequently used particularly in the area of epoxide-based reactive adhesives. The skilled person tailors the catalyst system used for curing substantially to the application requirements and to the polymerizable epoxide compounds used.

With a view to the later handling properties, it is particularly advantageous in the estimation of the inventors to use radiation-crosslinking and/or thermally crosslinking systems, with radiation activation in particular providing large handling advantages. Preferred in this case is a curable adhesive of the invention wherein the one or the two or more cationic initiators are selected from the group consisting of radiation-activated initiators and thermally activated initiators, preferably are selected from the group consisting of radiation-activated initiators, or wherein the curable adhesive is a radiation-curing and/or thermally curing, preferably radiation-curing, adhesive.

Examples of preferred thermally activated cationic initiators are latent, thermally activatable cationic initiators (TAG; thermal acid generators). Suitable TAG are known to the skilled person and are available commercially from numerous suppliers. Preferred TAG are those comprising a cation selected from the group consisting of 4-substituted benzylanilinium, 4-substituted benzylpyridinium, 4-substituted benzylphosphonium, S-substituted diphenylsulfonium and substituted aryl-benzylsulfonium, preferably selected from the group consisting of 4-substituted benzylanilinium. The TAG may in principle contain any desired anion, with preference being given to weakly coordinating anions such as tetrafluorborate (BF₄⁻), hexafluorophosphate (PF₆⁻), hexafluoroantimonate (SbF₆⁻), tetrakis(pentafluorophenyl)borate (B(C₆F₅)₄⁻) and trifluoromethylsulfonate (F₃CSO₃⁻). Particularly preferred here are trifluoromethylsulfonate (F₃CSO₃⁻) and hexafluoroantimonate (SbF₆⁻).

Advantageous combinations of a TAG composed of cation and anion are those for which the resulting initiator has an activation temperature in the range from 50° C. to 150° C., with the skilled person adjusting the activation energy preferably with respect to the particular application requirements, with a range from 80° C. to 120° C. in particular being preferred in many cases, to allow the polymerization to be carried out at a comparatively moderate activation temperature while nevertheless permitting a clearly delimited initiation. The activation temperature of reactive or chemically activatable adhesives in general, or of the TAG used, is determined calorimetrically by way of differential scanning calorimetry (DSC) according to DIN EN ISO 11357-3:2013-04. For this purpose, approximately 20 mg of the sample are weighed out into an aluminium crucible and introduced into the instrument (instrument: DSC 204 F1, from Netzsch). Then two heating curves are recorded with a heating rate of 10 K/min. The specimens are measured in Al crucibles with perforated lid under a nitrogen atmosphere. A chemical reaction such as activation of the TAG is apparent as an exothermic peak in the thermogram. The onset temperature is recorded as the activation temperature. It is determined for a peak as the point of intersection of the virtual interpolated baseline with the tangent placed at the inflection point of the incipient peak (according to DIN EN ISO 11357-1:2010-03). Integration of the curing peak gives the enthalpy of reaction in J/g.

Initiators which can be used for cationic, radiation-based, i.e. frequently UV-induced, curing of epoxide compounds are, in particular, sulfonium-, iodonium- and metallocene-based systems. For examples of sulfonium-based cations, reference may be made to the observations in US 6,908,722 B1. Examples of anions which serve as counterions for the cations stated above include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis-(pentafluoromethylphenyl)-borate, bi-(trifluoromethylsulfonyl)-amides and tris-(trifluoromethylsulfonyl)-methides. Moreover, especially for iodonium-based initiators, conceivable anions also include chloride, bromide or iodide, although preferred initiators are those which are substantially free from chlorine and bromine. An effective example of such a system is, for example, triphenylsulfonium hexafluoroantimonate. Further suitable initiators are disclosed for example in U.S. Pat. Nos. 3,729,313 A, 3,741,769 A, 4,250,053 A, 4,394,403 A, 4,231,951 A, 4,256,828 A, 4,058,401 A, 4,138,255 A and US 2010/063221 A1.

Specific examples of sulfonium salts which can be used are particularly triarylsulfonium salts, for example triphenylsulfonium hexafluoroarsenate, triphenylsulfonium hexafluoroborate, triphenylsulfonium tetrafluoroborate, triphenylsulfonium tetrakis-(pentafluorobenzyl)-borate, methyldiphenylsulfonium tetrafluoroborate, methyldiphenylsulfonium tetrakis-(pentafluorobenzyl)-borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenyl-sulfonium hexafluoroantimonate, 4-butoxyphenyldiphenylsulfonium tetrafluoroborate, 4-chlorophenyl-diphenylsulfonium hexafluoroantimonate, tris-(4-phenoxyphenyl)-sulfonium hexafluorophosphate, di-(4-ethoxphenyl)-methylsulfonium hexafluoroarsenate, 4-acetylphenyldiphenylsulfonium tetrafluoroborate, 4-acetylphenyldiphenylsulfonium tetrakis-(pentafluorobenzyl)-borate, tris-(4-thiomethoxyphenyl)-sulfonium hexafluorophosphate, di-(methoxysulfonylphenyl)-methylsulfonium hexafluoroantimonate, di-(methoxy-naphthyl)-methylsulfonium tetrafluoroborate, di-(methoxynaphthyl)-methylsulfonium tetrakis-(penta-fluorobenzyl)-borate, di-(carbomethoxyphenyl)-methylsulfonium hexafluorophosphate, (4-octyloxyphenyl)-diphenylsulfonium tetrakis-(3,5-bis-trifluoromethylphenyl)-borate, tris-[4-(4-acetylphenyl)-thiophenyl]-sulfonium tetrakis-(pentafluorophenyl)-borate, tris-(dodecylphenyl)-sulfonium tetrakis-(3,5-bis-trifluoromethylphenyl)-borate, 4-acetamidophenyldiphenylsulfonium tetrafluoroborate, 4-acetamidophenyldiphenylsulfonium tetrakis-(pentafluorobenzyl)-borate, dimethylnaphthylsulfonium hexafluorophosphate, trifluoromethyldiphenyl-sulfonium tetrafluoroborate, trifluoromethyldiphenylsulfonium tetrakis-(pentafluorobenzyl)-borate, phenylmethylbenzylsulfonium hexafluorophosphate, 5-methylthian-threnium hexa-fluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis-(pentafluorobenzyl)-borate, 5-methyl-10-oxothianthrenium tetrafluoroborate, 5-methyl-10-oxothianthrenium tetrakis-(pentafluorobenzyl)-borate and 5-methyl-10,10-dioxothianthrenium hexafluorophosphate.

Specific examples of iodonium salts which can be used are diphenyliodonium tetrafluoroborate, di-(4-methylphenyl)-iodonium tetrafluoroborate, phenyl-4-methylphenyliodonium tetrafluoroborate, di-(4-chlorphenyl)-iodonium hexafluorophosphate, dinaphthyliodonium tetrafluoroborate, di-(4-trifluormethyl-phenyl)-iodonium tetrafluoroborate, diphenyliodonium hexafluorophosphate, di-(4-methylphenyl)-iodonium hexafluorophosphate, diphenyliodonium hexafluoroarsenate, di-(4-phenoxyphenyl)-iodonium tetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodonium tetrafluoroborate, di-(2,4-dichlorophenyl)-iodonium hexafluorophosphate, di-(4-bromophenyl)-iodonium hexafluorophosphate, di-(4-methoxyphenyl)-iodonium hexafluorophosphate, di-(3-carboxyphenyl)-iodonium hexafluorophosphate, di-(3-methoxycarbonylphenyl)-iodonium hexafluorophosphate, di-(3-methoxysulfonylphenyl)-iodonium hexafluorophosphate, di-(4-acetamidophenyl)-iodonium hexafluoro-phosphate, di-(2-benzothienyl)-iodonium hexafluorophosphate, diaryliodonium tristrifluoromethylsulfonylmethide such as diphenyliodonium hexafluoroantimonate, diaryliodonium tetrakis-(pentafluorophenyl)-borate such as diphenyliodonium tetrakis-(pentafluorophenyl)-borate, [4-(2-hydroxy-n-tetradesiloxy)-phenyl]-phenyliodonium hexafluoroantimonate, [4-(2-hydroxy-n-tetradesiloxy)-phenyl]-phenyliodonium trifluorosulfonate, [4-(2-hydroxy-n-tetradesiloxy)-phenyl]-phenyliodonium hexafluorophosphate, [4-(2-hydroxy-n-tetradesiloxy)-phenyl]-phenyliodonium tetrakis-(pentafluorophenyl)-borate, bis-(4-tert-butylphenyl)-iodonium hexafluoroantimonate, bis-(4-tert-butylphenyl)-iodonium hexa-fluorophosphate, bis-(4-tert-butylphenyl)-iodonium trifluorosulfonate, bis-(4-tert-butylphenyl)-iodonium tetrafluoroborate, bis-(dodecylphenyl)-iodonium hexafluoroantimonate, bis-(dodecylphenyl)-iodonium tetrafluoroborate, bis-(dodecylphenyl)-iodonium hexafluorophosphate, bis-(dodecylphenyl)-iodonium trifluoromethylsulfonate, di-(dodecylphenyl)-iodonium hexafluoroantimonate, di-(dodecylphenyl)-iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bis-succinimidodiphenyliodonium bisulfate, 3-nitrodiphenyliodonium bisulfate, 4,4′-dimethoxydiphenyliodonium bisulfate, bis-(dodecylphenyl)-iodonium tetrakis-(pentafluorophenyl)-borate, (4-octyloxyphenyl)-phenyliodonium tetrakis-(3,5-bis-trifluoromethylphenyl)-borate and (tolylcumyl)-iodonium tetrakis-(pentafluorophenyl)-borate, and ferrocenium salts (see for example EP 0 542 716 B1) such as η5-(2,4-cyclopentadien-1-yl)-[(1,2,3,4,5,6,9)-(1-methylethyl)-benzenel]iron.

Photoinitiators are typically used individually or as a combination of two or more photoinitiators. When photoinitiators are used, combinations with other additives for adapting the activation wavelength of the photoinitiation system to the chosen emission spectrum are also possible, for which reference is made to the literature known to the skilled person, such as, for example, “Industrial Photoinitiators: A technical guide” 2010 by A. W. Green. Preferred, however, is a curable adhesive of the invention wherein the curable adhesive comprises substantially no additives for adapting the activation wavelength.

Largely independently of the selection of the specific cationic initiator, preference is given to a curable adhesive of the invention wherein the combined mass fraction of the cationic initiators in the curable adhesive is in the range from 0.1% to 7%, preferably in the range from 0.3% to 5%, more preferably in the range from 0.5% to 4%, based on the mass of the curable adhesive.

Largely independently of the selection of the specific dye, preference is given to a curable adhesive of the invention wherein the combined mass fraction of the dyes in the curable adhesive is in the range from 0.05% to 1%, preferably in the range from 0.1% to 0.3%, based on the mass of the curable adhesive.

Also preferred, additionally or alternatively, is a curable adhesive of the invention wherein the combined mass fraction of the dyes in the curable adhesive is 0.25% or less, preferably 0.2% or less, based on the mass of the curable adhesive, and/or wherein the combined mass fraction of the dyes in the curable adhesive is 0.1% or more, preferably 0.15% or more, based on the mass of the curable adhesive.

It may be seen as an advantage of the curable adhesives of the invention that they are very flexible in terms of the presence of further components, it becoming possible advantageously as a result for the physicochemical properties to be tailored in a particularly targeted way to the respective requirements of the applications. Preferred, for example, is a curable adhesive of the invention which comprises one or more polyols, preferably in a combined mass fraction in the range from 0.5% to 15%, particularly preferably in the range from 1% to 10%. Preferred additionally or alternatively is also a curable adhesive of the invention which comprises one or more further additives, preferably in a combined mass fraction in the range from 0.1% to 50%, more preferably in the range from 0.2% to 40%, based on the mass of the curable adhesive, and/or wherein the one or the two or more further additives are preferably selected from the group consisting of tackifier resins, ageing inhibitors, light stabilizers, UV absorbers, rheological additives and additives for increasing the opacity.

In specific applications, an opacity (“haze”) may be desired for the curable adhesive of the invention or for the adhesive tape comprising the curable adhesives of the invention. Such specific applications are, for example, adhesive tapes for the electrical insulation of an article, such as battery cells, for example. Here, a certain opacity is desirable in order to conceal visual defects such as scratches, for example. Preferred accordingly is the curable adhesive of the invention which as well comprises one or more additives for increasing the opacity. Having emerged as being particularly advantageous in relation to adhesive curability, colour strength and hiding power are combinations of a combined mass fraction of not more than 0.3% of one or more dyes and with a combined mass fraction of not more than 5% of one or more additives for increasing the opacity, based on the mass of the curable adhesive.

Especially preferred are curable adhesives of the invention wherein the combined mass fraction of the dyes in the curable adhesive is in the range from 0.1% to 0.25% and the combined mass fraction of the additives for increasing the opacity, especially of titanium dioxide, is in the range from 0.1% to 0.3%, based on the mass of the curable adhesive.

A particular case of the further components which serve to adjust the properties of adhesives are insoluble fillers, which may be added to the curable adhesive to obtain a filled curable adhesive. These fillers are particulate fillers having an average particle diameter (D50) of 5 μm or more, preferably 10 μm or more, more preferably 20 μm or more, which are insoluble in the curable adhesive and present in the latter, correspondingly, as a dispersion, and also macroscopic fillers such as fibres, for example. The insoluble fillers are preferably selected from the group consisting of particulate fillers, such as titanium dioxide, for example. More preferably, the insoluble fillers are selected from the group consisting of expandable hollow polymer beads, non-expandable hollow polymer beads, solid polymer beads, hollow glass beads, solid glass beads, hollow ceramic beads, solid ceramic beads and/or solid carbon beads. Also candidates for insoluble fillers, however, are—for example—fibres, laid scrims, platelets and rodlets of materials insoluble in the curable adhesive. As a result of their in some cases already macroscopic dimensions and of the lack of solubility, they have substantially no influence on the above-disclosed relationships in the compositional chemistry of the curable adhesives, being present instead in a heterogeneous mixture with the curable adhesive. Correspondingly, in the context of the present invention, these insoluble fillers are not counted as part of the curable adhesive and are therefore not considered when calculating mass fractions relative to the mass of the curable adhesive. In the context of the present invention, the addition of insoluble fillers to a curable adhesive of the invention is instead defined as resulting in a filled curable adhesive, i.e. a filled curable adhesive comprising:
i) a curable adhesive of the invention, preferably as disclosed above as being preferred, and
ii) one or more insoluble fillers.

With particular preference, the combined mass fraction of the insoluble fillers here is in the range from 1% to 50%, preferably in the range from 2% to 40%, more preferably in the range from 5% to 30%, based on the mass of the filled curable adhesive.

Fillers are usually not suitable for liquid curable adhesives. Moreover, the majority of fillers result in an opacity which is unwanted in many cases, as it unnecessarily attenuates the depth of penetration of the UV radiation. For this reason, preference is given to curable adhesives of the invention to which no filler is added and which correspondingly are substantially free of fillers.

Curable adhesives of the invention may be used, for example, directly as adhesives, and according to application method may be provided in particular in the form of tapes. The invention therefore also relates to an adhesive tape, more particularly a reactive adhesive tape, comprising as adhesive layer a curable adhesive of the invention, with the adhesive tape preferably comprising a carrier layer.

With a view to the most favourable possible handling qualities, particularly advantageous results are generally achieved when curable adhesives of the invention are used as an adhesive layer in a single-sided or double-sided adhesive tape, when this tape either also comprises a carrier layer or the adhesive layer is arranged on a release layer, a liner for example, from which the adhesive layer is easily detachable.

The concept of adhesive tape is clear to the skilled person in the field of adhesive technology. In the context of the present invention, the expression “tape” refers to all thin, sheetlike structures, i.e. structures having a predominant extent in two dimensions, especially films, film portions and labels, preferably tapes with extended length and limited width, and also corresponding tape portions.

The carrier layer usually denotes that layer of a multilayer adhesive tape of this kind that critically determines the mechanical and physical properties of the adhesive tape, such as the tensile strength, stretchability, insulation capacity or resilience, for example. Customary materials for the carrier layer are, for example, woven fabrics, laid scrims and polymeric films, examples being PET films and polyolefin films. The carrier layer, however, may also itself be pressure-sensitively adhesive. In one preferred embodiment, the adhesive tape of the invention may be a double-sided adhesive tape whose carrier layer is provided on both sides with a curable adhesive of the invention.

The carrier layer may also have electrically insulating properties, and so the corresponding adhesive tape of the invention is electrically insulating and can be used for the electrical insulation of an article. For this purpose it is possible to use insulating carrier films having a specific volume resistivity of>10¹⁵ Ωcm, preferably>10¹⁶ Ωcm, more preferably>10¹⁷ Ωcm, determined according to DIN EN 62631-3-1 (VDE 0307-3-1):2017-01. The adhesive tape of the invention may accordingly, in one preferred embodiment, be a double-sided adhesive tape whose insulating carrier film is provided on both sides with a curable adhesive of the invention. In another preferred variant, the adhesive tape of the invention is a single-sided adhesive tape whose electrically insulating carrier film is provided on one side with a curable adhesive of the invention. Such single-sided adhesive tapes are outstandingly suitable for enveloping battery cells in hybrid vehicles and all-electric vehicles.

The insulating carrier film preferably comprises one or more materials selected from the group consisting of polyimide, polybenzimidazole, polyamideimide, polyetherimide, polyacetal, polyphenylene sulfide, polyether ether ketone, polytetrafluoroethylene, nylon 6, ultra-high molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate copolymer and polyester, more preferably from the group consisting of polypropylene, polyethylene terephthalate, polycarbonate and polyvinyl chloride, more preferably from the group consisting of polypropylene and polyethylene terephthalate.

As far as the thickness of the carrier is concerned, there are in principle no particular restrictions. The carrier preferably has a thickness in the range from 20 μm to 100 μm, more preferably in the range from 30 μm to 90 μm, more preferably in the range from 40 μm to 75 μm.

In adhesive tapes of the invention, the adhesive layers may be lined with a release covering, called a release liner, in order to enable trouble-free unwinding and to protect the pressure-sensitive adhesive from fouling. Such release liners customarily consist of a single-sidedly or double-sidedly siliconized polymeric film (e.g. PET or PP) or of a siliconized paper carrier.

Starting from the curable adhesive of the invention and from the adhesive tape of the invention, moreover, the use is disclosed of a curable adhesive of the invention or of an adhesive tape of the invention for the bonding of two or more components by curing of the curable adhesive, preferably in a process of the invention.

The invention and preferred embodiments of the invention are further explained and described below with reference to experiments.

### A. Preparation of the Curable Adhesives

Curable adhesives were obtained from the constituents collated in Table 1, by mixing of the components in a customary manner (as laboratory drawdowns from a 40% butanone solution).

TABLE 1
Composition of the curable adhesives; all figures in parts by weight.

| | I1 | I2 | I3 | I4 | I5 | C1 | C2 |
|---|---|---|---|---|---|---|---|
| Levamelt 700 | 10 | 40 | 40 | 40 | 40 | 40 | 40 |
| D.E.R. 331 | 60 | 30 | 30 | 30 | 30 | 30 | 30 |
| D.E.R. 662E | 20 | 20 | 20 | 20 | 20 | 20 | 20 |
| Capa 2054 | 10 | 10 | 10 | 10 | 10 | 10 | 10 |
| Benzoyl-Leuco-Methylene Blue | 0.2 | | | | | | |
| Nile Blue | | 0.2 | | | | | |
| Ethyl Violet | | | 0.1 | | | | |
| 1,4-Bis(mesitylamino)anthraquinone | | | | 0.1 | | | |
| Copper phthalocyanine | | | | | 0.1 | | |
| Sudan Blue II | | | | | | 0.2 | 0.1 |
| Triarylsulfonium hexafluorophosphate | 3 | 3 | 3 | 3 | 3 | | 3 |
| (50% in propylene carbonate) | | | | | | | |
| Diaryliodonium hexafluorophosphate | | | | | | 1.5 | |
| (75% in propylene carbonate) | | | | | | | |
| 2,2-Dimethoxy-2-phenylacetophenone | | | | | | 1 | |

The (co)polymer used was the commercially available ethylene-vinyl acetate copolymer Levamelt® 700 (vinyl acetate content of 70 per cent by weight) from Arlanxeo.

Epoxide compounds used were a commercially available solid bisphenol-A diglycidyl ether (trade name D.E.R. 662E) and a commercially available liquid bisphenol-A diglycidyl ether (trade name D.E.R. 331) from Olin.

The cationic initiator used in samples I1 to I4, C2 and C3 was triarylsulfonium hexafluorophosphate (50% in propylene carbonate; CAS: 109037-77-6; the figures for the initial mass in Table 1 are based on the solution).

The cationic initiator system used in sample C1 was diaryliodonium hexafluorophosphate (Omnicat 250, CAS: 344562-80-7; 75% in propylene carbonate; the figures for the initial mass in Table 1 are based on the solution) in combination with 2,2-dimethoxy-2-phenylacetophenone (Irgacure 651, CAS: 24650-42-8).

The polyol used was a commercially available polyester polyol based on polycaprolactone (trade name Capa 2054) from Ingevity.

From the curable adhesives prepared, adhesive tapes having a thickness of about 100 μm were produced by drawdowns from the solid curable adhesives I2 to I5 and C1 to C3.

### B. Bonding Experiments & Colour Rating

Peel adhesion:

The peel adhesion forces were determined in analogy to ISO 29862 (Method 3) at 23° C. and 50% relative humidity with a removal speed of 300 mm/min and a removal angle of 180°. The thickness of the layer of adhesive in each case was 100 μm. The reinforcing film used was an etched PET film having a thickness of 50 μm, as available from Coveme (Italy). The substrates used were steel plates in line with the standard. The bonding of the uncured measuring strip was performed by means of a roller application machine at 4 kg at a temperature of 23° C. The adhesive tapes were peeled off immediately after application. The measured value (in N/cm) was obtained as the average value from three individual measurements, and the failure mode was recorded as follows: adhesive failure (A) or cohesive failure (C).

### Colouration:

For each of the curable adhesives, the colour of the cured adhesives was determined 7d after initiation of the curing with a Höhnle 365 nm UV-LED and a dose of 4 J/cm².

The results are shown in Table 2.

TABLE 2
Summary of the bonding experiments

| | I1 | I2 | I3 | I4 | I5 | C1 | C2 |
|---|---|---|---|---|---|---|---|
| Fracture | C | A | A | A | A | A | A |
| mode*/ | (n.d.) | (>1 | (>1 | (>1 | (>1 | (>1 | (>1 |
| Peel | | N/cm) | N/cm) | N/cm) | N/cm) | N/cm) | N/cm) |
| adhesion | | | | | | | |
| (before | | | | | | | |
| curing) | | | | | | | |
| Colour before | colourless | blue | blue | blue | blue | blue | blue |
| curing | | | | | | | |
| Colour after | blue | blue | blue | blue | blue | yellow | purple |
| curing | | | | | | | |

*A: adhesive failure;
C: cohesive failure

The fracture mode in the peel adhesion test indicates advantageous cohesion and pressure-sensitive adhesive properties for samples I2 to I5. The liquid adhesive I1, as expected, exhibits cohesive failure prior to curing, and so no useful peel adhesion can be determined.

For the curable adhesives of the invention, the desired blue colour is manifested after curing in an advantageous way. Samples 14 and 15 are blue even prior to irradiation, whereas I2 and I3 pass through an interim colour change before reaching the final, cured, blue-coloured state. The blue colour is retained even after storage under hot and humid conditions (7 days of curing at 23° C. and 50% relative humidity and 48 hours of storage at 85° C. and 85% relative humidity).

C1 is an example showing how difficult it is for the skilled person to select a suitable dye. When an initiator system is used with an additive for adapting the activation wavelength of the photoinitiation system for Sudan Blue II, accordingly, a yellow colouration comes about, surprisingly. C2 is indeed blueish prior to irradiation, but after the irradiation a cured purple adhesive, which still changes slightly in its shade over time, is obtained.

1. Curable adhesive comprising:
a) one or more (co)polymers,
b) one or more polymerizable epoxide compounds,
c) one or more cationic initiators, and
d) one or more dyes,
wherein the one or the two or more dyes are selected from the group consisting of Benzoyl-Leuco-Methylene Blue, Leuco-Crystal Violet, Crystal Violet Lactone, Ethyl Violet, Methyl Violet, Methyl Green, Ethyl Green, Nile Blue, 1,4-bis(mesitylamino)anthraquinone and copper phthalocyanine.

2. Curable adhesive according to claim 1, wherein the curable adhesive is a pressure-sensitive adhesive.

3. Curable adhesive according to claim 1, wherein the one or the two or more dyes are selected from the group consisting of Benzoyl-Leuco-Methylene Blue, Leuco-Crystal Violet, Crystal Violet Lactone, Ethyl Violet, Methyl Violet, Nile Blue, 1,4-bis(mesitylamino)anthraquinone and copper phthalocyanine.

4. Curable adhesive according to claim 3, wherein the one or the two or more dyes are selected from the group consisting of Benzoyl-Leuco-Methylene Blue, Ethyl Violet, Nile Blue, 1,4-bis(mesitylamino)anthraquinone and copper phthalocyanine.

5. Curable adhesive according to claim 1, wherein the combined mass fraction of the dyes in the curable adhesive is in the range from 0.05% to 1%, based on the mass of the curable adhesive.

6. Curable adhesive according to claim 1, wherein the combined mass fraction of the cationic initiators in the curable adhesive is in the range from 0.1% to 7%, based on the mass of the curable adhesive.

7. Curable adhesive according to claim 1, wherein the combined mass fraction of the (co)polymers in the curable adhesive is in the range from 1% to 70%, based on the mass of the curable adhesive.

8. Curable adhesive according to claim 1, wherein the combined mass fraction of the polymerizable epoxide compounds in the curable adhesive is in the range from 35% to 95%, based on the mass of the curable adhesive.

9. Curable adhesive according to claim 1, wherein the curable adhesive comprises one or more polymerizable epoxide compounds which are selected from the group of epoxide compounds which at 25° C. are solids or high-viscosity substances having a dynamic viscosity of 50 Pa s or more, and/or wherein the curable adhesive comprises one or more polymerizable epoxide compounds which are selected from the group of epoxide compounds which at 25° C. are a liquid having a dynamic viscosity of 40 Pa s or less.

10. Adhesive tape comprising as adhesive layer a curable adhesive according to claim 1.
